(19) United States
(12) Patent Application Publication
(10) Pub. No.: US 2005/0085243 A1
(43) Pub. Date: Apr. 21, 2005

(54) Contextual communications

(75) Inventors: David Gray Boyer, Oceanport, NJ (US); Bruce Emery Tillinger, Morristown, NJ (US)

Correspondence Address: DEMONT & BREYER, LLC, SUITE 250, 100 COMMONS WAY, HOLMDEL, NJ, 07733, US

(73) Assignee: Avaya Technlogy Corp., Basking Ridge, NJ (US)

(21) Appl. No.: 10/951,386

(22) Filed: Sep. 28, 2004

Related U.S. Application Data
(60) Provisional application No. 60/507,067, filed on Sep. 29, 2003.

(51) Int. Cl. H04Q 7/20

(52) U.S. Cl. 455/463

(57) ABSTRACT

A method is disclosed to streamline the process of collaboration. In accordance with the illustrative embodiment, a plurality of individuals are associated with an electronic document or application of interest. The illustrative embodiment includes the operations of activating the document or application and then initiating communication between at least some of the associated individuals by a single action or command.

### REFERENCE TO RELATED APPLICATIONS

This application claims the benefit of U.S. provisional patent application Ser. No. 60/507067, filed 29 Sep. 2003, entitled “Contextual Communications,” which is also incorporated by reference.

### FIELD OF THE INVENTION

The present invention relates to telecommunications, and more particularly to collaborative communications.

### BACKGROUND OF THE INVENTION

A user of an electronic document (e.g., a Word™ file, an Excel™ file, an e-mail file, etc.) might, at times, need to reach others that are in some way associated (e.g., co-authors, etc.) with the document. For example, assume that one of three co-workers is drafting a document that summarizes the collective efforts of the three co-workers on a project. The drafter requires information from the other two co-workers. To obtain the required information, the drafter might send (e.g., via e-mail, etc.) an electronic copy of the document to the co-workers and attempt to establish a conference call. This will require that the drafter obtain contact numbers (e.g., URL, phone number, etc.) of the co-workers, send the document to them and place the telephone calls. Of course, attempts at communication can be frustrated by an inability to reach one or both of the co-workers.

As a consequence, it would be beneficial if this process of communication and collaboration could be streamlined.

### SUMMARY OF THE INVENTION

The present invention provides a mechanism for streamlining the collaborative process. In accordance with the illustrative embodiment, a user of an electronic device (e.g., PC, PDA, etc.) initiates communication with other individuals that are associated with a specific document or application of interest that is stored in the electronic device. The identity of the individuals that are to participate in the communication is determined based on what the user is doing with the electronic device; that is, which document or application is active.

In the illustrative embodiment, communication is established by (1) activating the document or application of interest (if it's not already active) and then (2) initiating communications between the associated individuals via a single action. The action can be, for example, activating a single soft key or issuing a voice command via the telecommunication capabilities of the electronic device in which the document or application is stored.

Once action is taken to initiate communications, the electronic device, in conjunction with contextual communications software:
determines which document or application is active (i.e., currently has the focus of the electronic device);
accesses information that indicates which individuals are associated with the active document or application and obtains relevant contact information for those individuals; and
establishes communication with those individuals.

The communication can be a notification (i.e., a call, a voice mail, or text message on devices specified in the contact information), a conference (i.e., voice, IM session, etc.) or a collaboration (i.e., conference plus sharing the document or application). Communications are supported by, for example, an IP network, the public-switched telephone network, or cellular-phone network.

By handling communications in the context of the document or application of interest, the illustrative embodiment of the present invention eliminates having to set up the communication in a more manual and typically less efficient fashion.

### BRIEF DESCRIPTION OF THE DRAWINGS

FIG. 1 depicts a method in accordance with the illustrative embodiment of the present invention.

FIG. 2 depicts two open documents, one of which is active.

FIG. 3 depicts a method by which the method of FIG. 1 is implemented.

FIG. 4 depicts sub-tasks of the method of FIG. 3.

FIG. 5 depicts a data structure comprising a list of individuals that are associated with a document or application of interest.

### DETAILED DESCRIPTION

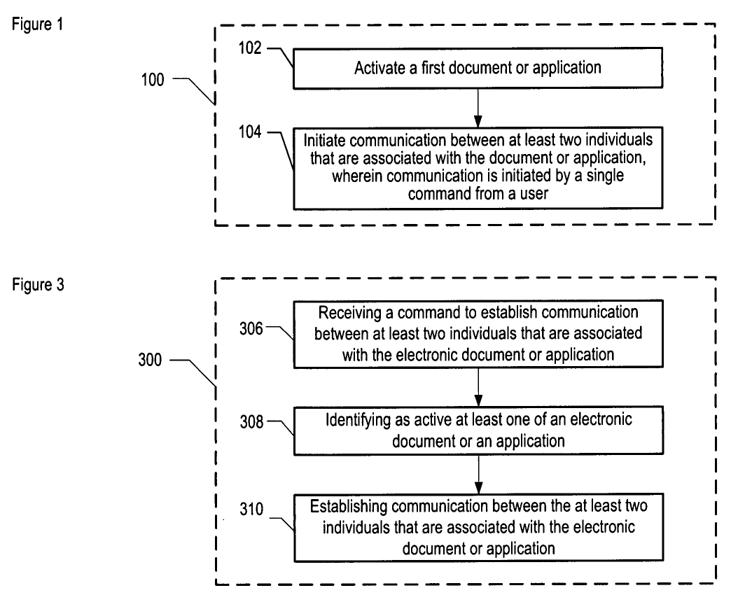

FIG. 1 depicts a flowchart of method 100 in accordance with the illustrative embodiment of the present invention. Method 100 provides context-based notification, conferencing, or collaboration capabilities for communications-device users. Several aspects of the illustrative method are particularly noteworthy and are set forth below to provide a framework and context for the description that follows. In particular:
The method enables a user, with the “click” of a button or by a simple verbal command, to perform an instant “notification,” to establish an instant “conference,” or create an instant “collaboration.”
The recipients of the notification, the participants in the conference or collaboration, and the document or application to be shared are determined in the context of what a user is doing on the electronic device.
The approach used for determining context is different from prior art approaches, which typically require that communication capabilities be added directly to applications or portals.
The method enables a user that is conferencing with others to share documents and applications without the need to manually initiate a parallel Web-based conference via appropriate software packages (e.g., WebEx, etc.).

Referring now to FIG. 1, method 100, at task 102, a user activates a document, an application, or both, which is stored on an electronic device (e.g., a personal computer, a personal digital assistant, etc.). The document is a data file, such as a Microsoft Word file, an Adobe PDF file, an e-mail file, etc., used by one or more application programs. The application program can be literally any program, including word processing applications, spread sheet applications, simulation programs, project management tools, source control programs, e-mail readers, games, etc.

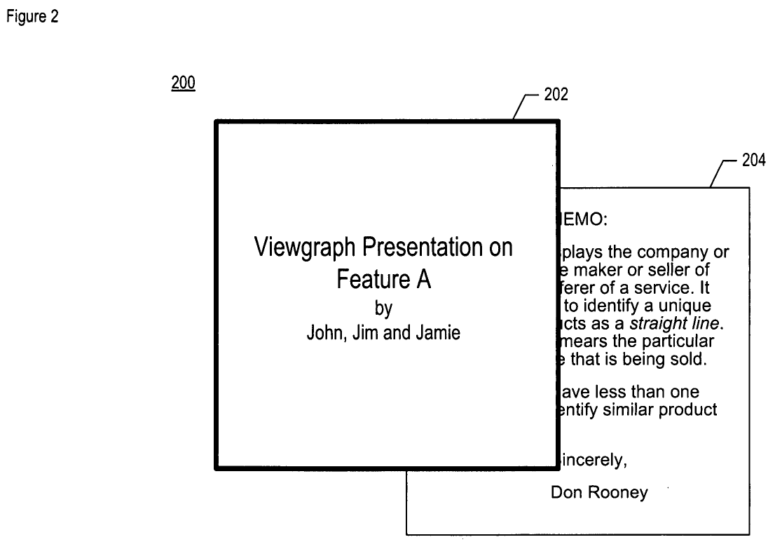

A variety of documents and programs can be “open” on the desktop of a personal computer at one time. In particular, in the Microsoft Windows graphical interface, each open document or application resides in a different window. But only one window, and, hence, one document or application, can be active at one time. For example, in FIG. 2, there are two documents, 202 and 204, that are open in desktop 200. The active document (i.e., the document that has the “focus” of the electronic device) is document 202.

A user activates a document or program of interest among several open documents and applications by, for example, “clicking” on the window or ikon that is associated with the document or application. The window that has the focus of the electronic device, which is the window in which the activated document or application resides, is referred to herein as the “contextual window.” The contextual window is the window to which contextual communication software looks to find the document or application that is to be the focus of contextual communications.

At task 104, a user initiates communication between at least two individuals that are associated with the active document or application. As described in further detail later in this specification, an “associated” individual is someone that is involved in some manner with the document or application of interest. This task is performed using a single command, such as by clicking on a single soft key or verbalizing the request using a voice interface. The communication can be a “notification,” a “conference,” or a “collaboration;” these concepts are described in detail later in this specification. In some embodiments, a user selects the type of communication that is desired by clicking on one of three different soft keys, etc., one for “notification,” one for “conference,” and one for “collaboration.”

FIG. 3 depicts a flow chart of method 300 in accordance with the illustrative embodiment of the present invention. Method 300 defines tasks that are performed by the electronic device (on which the document or application of interest resides) when a user performs task 104 (i.e., initiates communication).

At task 306, a command is received to establish communication between at least two individuals that are associated with the active electronic document or application.

To perform task 306, the active document or application is identified. This is accomplished in task 308 by contextual communications software (running on the electronic device), which utilizes information in the electronic device that indicates which window is the contextual window or otherwise indicates which document or application is active. Those skilled in the art are familiar with what this information is and how to access it.

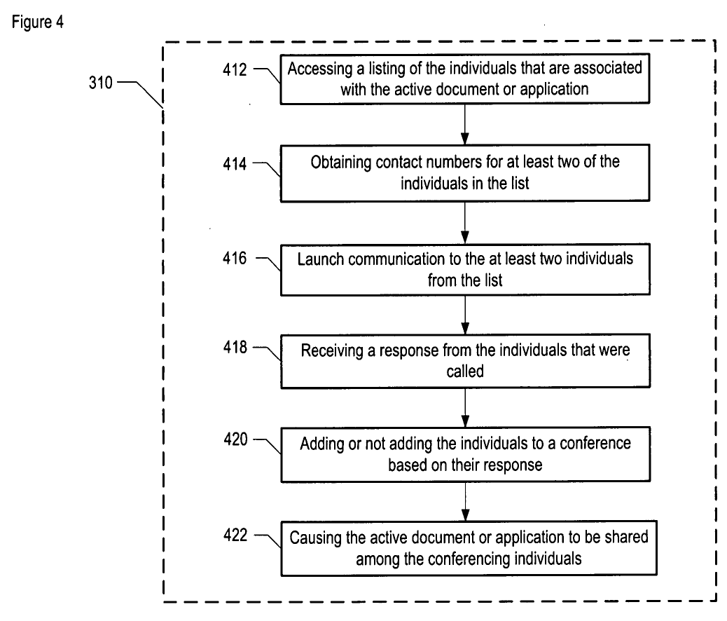

At task 310, the electronic device, in conjunction with the contextual communications software, establishes communication between at least two individuals that are associated with the electronic document or application of interest. FIG. 4 is a flow chart that depicts, for the illustrative embodiment, a variety of sub-tasks that are performed to execute task 310.

Referring now to FIG. 4, a listing of the individuals that are associated with the active document or application is accessed in sub-task 412. The concept of “associated” individuals is at the heart of the concept of contextual communications, as it is embodied herein. That is, in accordance with the illustrative embodiment of the invention, it is the associated individuals that will participate in the contextual communications. As used in this specification, the term “associated,” when used to describe the relationship between a document or application on one hand and particular individuals (e.g., John Doe, etc.) or individuals as identified by job title, etc. (e.g., V.P. of sales, etc.) on the other, means that those individuals have some connection or affiliation to the document/application such that a user working with the document or application might have some occasion to contact those individuals. Several non-limiting examples follow.

In a first example, four co-workers have developed a product. A document is being prepared to summarize the co-workers' efforts. The four co-workers are “associated” with the document. In a second example, a patent application is being prepared by a patent attorney at the request of the general counsel of a technology company. The “associated” individuals might be the patent attorney, the general counsel, and the inventors of the subject matter that is being disclosed in the patent application. In a third example, four individuals regularly compete against one another on an interactive electronic game. Those four individuals are associated with the application (game).

There are a variety of mechanisms or structures by which contextual communications software can identify an individual as being “associated” with a document or application. A few of these structures are described below.

For a Microsoft Office data file (e.g., a Word file, etc.), associated individuals can be listed in the “Properties” table of the data file under “Author,” etc. For non-generic documents, the appropriate section of the data file can be flagged as a direction to the contextual communications software to look to that section for the associated individuals. For an e-mail, associated individuals appear can appear in any one or more of the “From,” “To,” “cc,” and “bcc” lists. For applications that do not have structures from which to determine the associated individuals, a list of associated individuals can be created by the user.

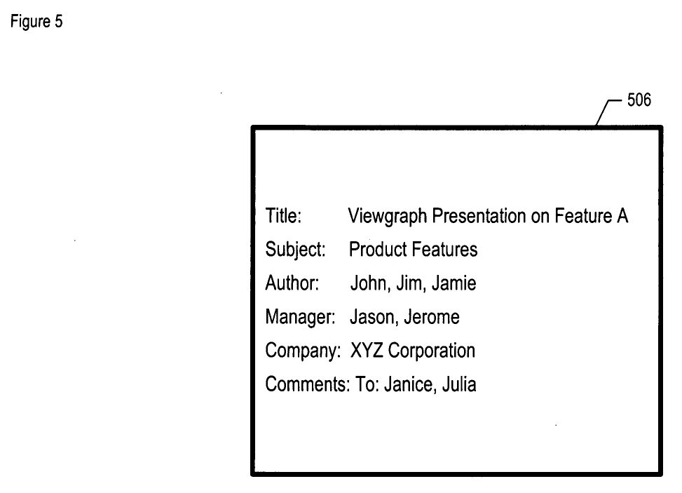

FIG. 5 depicts data structure 506 comprising the individuals that are associated with active document 202 of FIG. 2. Data structure 506 includes the “Title” of the document, the “Subject” of the document, the “Author” of the document, the “Manager” of the author(s), the “Company” involved, and additional “Comments.” Associated individuals can be found in the “Author” field and the “Manager” field. Furthermore, additional associated people can added in the “Comments” field, such as by adding a “To:” list or a “CC:” list. As a consequence, the “Author,” “Manager,” and “Comments” fields would be accessed for sub-task 412.

In accordance with the illustrative embodiment, the originator of the communication can select a subset of individuals for communication from the list of associated individuals. In other words, the user has the opportunity to drop (or add) associated individuals before contact (i.e., notification, conference, or collaboration) is made. In some embodiments, this is implemented as follows. After the command to initiate communications is given, an “initiate dialog” box appears with a list of associated individuals. In some embodiments, an indication is provided as to the availability of each listed individual, as determined, for example, by a presence server (discussed further below). The originator can then select some or all of individuals for participation in the forthcoming communication. Furthermore, the originator can decide to cancel the communication. This might occur, for example, if an insufficient number of individuals were available for the conference, or perhaps, if a key individual is not available.

Returning to the description of the sub-tasks of task 310 (see FIG. 4), contact number(s) for at least two of the associated individuals are obtained in sub-task 414. One of the two individuals can be the user; that is, the person initiating the contextual communications.

In some embodiments, contact number(s) (e.g., phone number, SIP URL, IP address, etc.) are maintained in an associated-individuals profile database, such as an SIP registrar that contains information pertaining to associated individuals' active communications devices. In some other embodiments, a presence server keeps track of current contact information for associated individuals. Associated individuals can register several numbers with the presence server. For example, an associated individual can provide a cell-phone number, a PSTN number, an e-mail address, etc. As described in further detail later in this specification, the presence server can be used to determine if an associated individual is “present.” In particular, assuming that the contact number is a cell-phone number, the presence server can determine whether or not that cell-phone is on.

At sub-task 416, communication is launched. In some embodiments, the communication is a “notification.” The notification can specify that a “conference” and/or “collaboration” is to begin immediately or at some time in the future. As used in this specification, the term “notification,” means a message (e.g., phone call, e-mail, etc.) that is electronically sent to an associated individual to inform them of a desire, on the part of an originator, to conference or collaborate.

In some embodiments, the electronic device receives a response to the notifications at sub-task 418. The electronic device then adds, to a conference, respondents that have agreed to participate, as per sub-task 420. As used in this specification, the term “conference” means interactive communication between two or more individuals. The communication can be via voice or otherwise (e.g., an IM session, etc.).

As an example of a conference, a user (e.g., a vice president of sales, etc.) associated with a regularly-updated document of divisional performance figures is tracking those figures. The data is presented on the user's personal digital assistant, and the user continually monitors the data. If the user notices that the projections are trending in a downward direction, the user wants to conference immediately with the user's regional sales directors. The user had previously set up the contact list of other individuals (i.e., the regional sales directors) that are associated with the document. The user clicks the contextual conference button after having activated the relevant document. All of the users are then brought into a conference call, in accordance with the illustrative embodiment of the present invention.

As is often desirable, the communication can be a “collaboration.” As used in this specification, the term “collaboration” refers to when a document or application is shared between two or more individuals. A “collaboration” can accompany a “conference,” and is accomplished at sub-task 422.

Document or application sharing is accomplished by a data-sharing application, such as Microsoft's NetMeeting, or via a web collaboration portal. If an associated individual responds affirmatively to a notification for collaboration, they would, in some embodiments, log into a data-sharing application or web collaboration portal wherein the document or application is pushed to them.

As an example of a collaboration, consider the two opened documents seen on computer desktop 200 in FIG. 2. Document 202 is active, as indicated by the darker window border, while document 204 is inactive. Document 202 is a viewgraph presentation co-authored by John, Jim, and Jamie. While editing document 202, John has a question for Jim and Jamie. John clicks a “contextual collaboration” button on his computer desktop tool bar to raise the other authors. The other authors would be notified of John's request wherever they are. If they accept the invitation for collaboration, they would be logged into a collaboration portal or a data sharing application and the document would be shared.

The following example provides further detail as to the mechanics of implementing a collaboration in accordance with the illustrative embodiment of the present invention. For this example, the context for communications is an e-mail.

Assume the John types an e-mail with an attachment that is to be sent to Jim and Jamie. Before sending the e-mail, John decides that he would prefer to have a conference with Jim and Jamie. Using a speech interface, John says, “contextual conference with Jim and Jamie.” Alternatively, a “start collaboration” button could be clicked. A call is then automatically placed to Jim, Jamie and John (i.e., each party's phone will ring without John having dialed any number). All three individuals will get a notification on the personal computer that they are requested to join a collaboration. The notification can be sent, for example, through WebEx, NetMeeting, etc., and is received, for example, on each party's personal computer. To the extent that each party affirmatively responds to the notification, such as by clicking on a “join collaboration” soft key, the e-mail and its attachment are automatically sent to them.

The tasks that are undertaken by John and his personal computer (“PC”), in conjunction with contextual communications software, to accomplish this collaboration are as follows:
John selects a “contextual conference” via voice, task bar button, etc.;
The PC identifies the active window on its desktop;
The PC accesses a listing of associated individuals for the conference from the active window;
The PC looks up each potential conferees registered contact number;
The PC sets up a dial-out conference with an audio conferencing bridge;
The PC calls each potential conferee and adds them to the conference;
The PC sends each potential conferee a collaboration message;
The PC launches each conferee's collaboration tool (e.g., WebEx, NetMeeting, etc.); and
The PC pushes the e-mail and its attachment to each conferee.

It will be clear to those skilled in the art which of the tasks depicted in FIGS. 1, 3, and 4 can be performed simultaneously or in a different order than that depicted.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents. What is claimed is:

1. A method comprising:
activating at least one of an electronic document or an application, wherein a plurality of individuals are associated with said electronic document or application; and
initiating communication between a user of said electronic document or application and at least one of said plurality of individuals by a single command.

2. The method of claim 1 wherein the operation of initiating communication is performed by actuating a button.

3. The method of claim 2 wherein said button is a soft key.

4. The method of claim 1 wherein said operation of initiating communication is accomplished by a voice command.

5. The method of claim 1 wherein said communication is selected from the group consisting of a notification, a conference, and a collaboration.

6. The method of claim 5 wherein, when said communication is a notification, initiating communication comprises sending a message to at least said one individual.

7. The method of claim 6 wherein initiating communication further comprises:
receiving a response from said at least one individual; and
admitting said at least one individual to a conference.

8. The method of claim 5 wherein said conference is one of a telephone call between said user and said at least one individual or an instant messaging session between said user and said at least one individual.

9. The method of claim 5 wherein said collaboration comprises sharing said electronic document or application between said user and said at least one individual.

10. The method of claim 9 wherein sharing comprises pushing said one document or application through a contextual collaboration portal.

11. The method of claim 1 wherein initiating communication comprises accessing contact information that is provided for at least said one individual.

12. The method of claim 11 wherein initiating communication further comprises placing a telephone call to said at least one individual.

13. The method of claim 12 wherein initiating communication further comprises pushing said one document or application to said at least one individual.

14. The method of claim 1 wherein initiating communication further comprises determining if said at least one individual is available.

15. The method of claim 14 wherein initiating communication further comprises not establishing a conference call when said at least one individual is not available.

16. The method of claim 1 wherein said plurality of individuals includes said user.

17. A method comprising:
activating at least one of an electronic document or an application that is stored on an electronic device, wherein a data structure associated with said electronic document or application comprises a listing of a plurality of individuals that are associated with said electronic document or application; and
establishing communication with at least one of said individuals via a single command issued to said electronic device by a user.

18. The method of claim 17 wherein establishing communication comprises:
accessing said listing; and
calling said at least one individual.

19. The method of claim 17 wherein establishing communication comprises:
accessing said listing;
calling said at least one individual; and
sharing said document or application between said user and said at least one individual.

20. The method of claim 17 wherein establishing communication comprises:
accessing said listing;
accessing a presence server; and
calling said one individual.

21. A method comprising:
identifying as active at least one of an electronic document or an application, wherein a plurality of individuals are associated with said document or application; and
receiving a command to establish communication between at least two of said individuals; and
establishing communication between said at least two individuals.

22. The method of claim 21 wherein establishing communication comprises establishing a conference between said at least two individuals.

23. The method of claim 22 wherein establishing communication further comprises sharing said at least one electronic document or application between said at least two individuals.
